(19) United States
(12) Patent Application Publication
(10) Pub. No.: US 2003/0024091 A1
(43) Pub. Date: Feb. 6, 2003

(54) Crypt front handing method and apparatus

(76) Inventors: Eric William Berryman, Gold Coast (AU); Geoffrey Meredith Marchant, Melton (AU)

Correspondence Address: Hoffman, Wasson & Gitler, P.C., Suite 522, 2361 Jefferson Davis Highway, Arlington, VA, 22202, US

(21) Appl. No.: 10/188,099

(22) Filed: Jul. 3, 2002

(30) Foreign Application Priority Data
Jul. 4, 2001 (AU) PR6086

(51) Int. Cl. A61G 17/00

(52) U.S. Cl. 27/27

(57) ABSTRACT

A method and apparatus for handling crypt fronts (86) normally supported in or forming a crypt wall (87) comprising crypt front engaging and supporting assemblies (11) mounted on a elevating or lowering device such as a scissor-link platform assembly (12) and having vacuum heads (34) which may be engaged with the crypt front (86). The vacuum heads (34) are supported by upper and lower linkage assemblies (52,53) which may be actuated to move the vacuum heads (34) and crypt front (86) out of the wall (87). The supporting assemblies (11) may also be pivoted to tilt the supported crypt fronts (86) for lowering or raising by the elevating or raising device (12).

### TECHNICAL FIELD

This invention relates to a method and apparatus for handling crypt fronts primarily for the purpose of the removal or placement of the fronts of crypts in a crypt wall.

### BACKGROUND ART

Burial crypts or mausoleums are becoming more popular for holding caskets or coffins as an alternative to the conventional cemeteries at which caskets or coffins are buried. The popularity of burial crypts or mausoleums is due to the decreasing ground areas available for burials and is also is a more attractive proposition for certain communities where placement of coffins or caskets in burial crypts is traditionally desirable.

Crypts which are currently in use or which are being constructed are in many different forms however in one configuration, a plurality of horizontal chambers for containing caskets or coffins are provided at various levels within a building. Some of the chambers are of a size to contain a single casket or coffin whilst other chambers are of a size to contain a plurality of caskets or coffins for example for family members. The chambers are closed at their sides and at one end (their inner end) and open at their other or outer end for receipt of the caskets or coffins. Caskets or coffins may be contained within a hollow sealed enclosure for location within the chambers.

The open ends of the chambers are sealed closed by end panels which are overlain by front panels or members which often are constructed of stone such as granite or marble. The front panels or members which usually are of a planar rectangular configuration are secured in position by screws at their corners or in a dovetail-type joint. The front members usually carry decorations such as lanterns and printing relating to the body or bodies contained therein.

Current procedures for handling the front members of the chambers involve the use of usually at least two workmen who are supported on a scissor lift by which they are elevated to the location at which the crypt front member is to be removed or placed. The front members are then gripped are removed manually. This procedure as well as being time consuming and difficult also may cause considerable dangers to workers. Further the decorations or other material on the front members makes it difficult for the front members to be gripped.

### SUMMARY OF THE INVENTION

The present invention aims to provide a method and apparatus which facilitates handling of crypt fronts and which overcomes or alleviates one or more of the above disadvantages. The present invention in particular aims to provide a method and apparatus which facilitates the removal of crypt fronts from a crypt wall or the placements of crypt fronts into a crypt wall Other objects and advantages of the invention will become apparent from the following description.

The present invention thus provides in a first preferred aspect, apparatus for handling crypt fronts of the type normally supported in or forming a crypt wall, said apparatus comprising:

vacuum head means,

means for applying a vacuum or partial-vacuum to said vacuum head means to enable said vacuum head means to grip said crypt front, and

means for supporting said vacuum head means for movement towards and away from a crypt wall for placement of a crypt front into, or removal of crypt front from, said crypt wall.

Preferably, the or each vacuum head means comprises an elongated body defining an elongated hollow recess which is open on one side and which is adapted to communicate with a vacuum or a partial vacuum source on their other side through for example a vacuum or suction pump. The open side of the recesses which comprises the side of the head adapted to abut a face of the crypt front is suitably provided with sealing means for sealing the recess to the crypt front to ensure sufficient suction is applied to the front to enable gripping thereof. The sealing means suitably comprise a sealing ring located in a groove surrounding the open side of the recess.

The apparatus suitably comprises one or more support frame assemblies arranged to support respective vacuum heads in a substantially upright attitude The support frame assembly or assemblies is/are preferably supported on an elevating and lowering device for raising and lowering the frame assembly/ies and vacuum head or heads carried thereby. The elevating device may comprise a platform assembly elevated and lowered for example by a scissor link arrangement however other mechanisms may be used for raising and lowering the platform assembly or support frame assemblies. The elevating device suitably comprises a mobile device supported for example on suitable wheels to enable the elevating device to be moved adjacent to a crypt wall or away from a crypt wall.

Each support frame assembly is preferably pivotally mounted for movement about a substantially horizontal axis to enable a crypt front when gripped by the vacuum head or heads to be tilted to overlie the elevating and lowering device for the purposes of stability and to clear any decorations on other crypt fronts during raising or lowering.

Suitably the support frame assemblies are adapted to be supported to one side or end of the elevating and lowering device. For carrying the support frame assemblies, a main support frame is detachably mountable to the elevating and lowering device. The main support frame may include means for supporting a support frame assembly a selected spaced positions thereon. The main support frame may include a plurality of spaced upstanding spigot-like frame members with which a support assembly may be engaged. The main support frame suitably includes an elongated frame member which is adapted to be detachably supported in a substantially horizontal attitude to the elevating and lowering device. For this purpose, the main support frame may be provided with arms which may extend into sockets in the elevating and lowering device. The elongated frame member suitably supports the spigot-like frame members at spaced positions therealong for engagement by the support frame assemblies.

Each support frame assembly suitably includes a main support arm which is mountable to the main support frame. The main support arm suitably comprises a lower socket part adapted to be located over a spigot-like frame member of the main support frame. The main support arm may also include an upper arm part pivotally mounted to the lower socket part for hinged or pivotal movement about a substantially horizontal pivot axis which thereby permits pivotal or hinged movement of the support frame assembly. Means may be provided for limiting the pivotal or hinged movement of the upper arm part relative to the lower socket part to limit tilting of the support frame assembly and in use a crypt front supported thereby.

Preferably each support frame assembly is mounted to the platform assembly in such a manner as to allow the vacuum head to be moved towards and away from the crypt wall. The support frame assembly for the vacuum head is also configured to allow for limited or fine adjustment of the vacuum head in a vertical direction and a sideways or lateral direction for accurate positioning of the vacuum head.

For the above purposes, each support frame assembly suitably includes a first frame member mounted to the main support arm for movement towards and away from the main support arm and towards and away from the platform assembly to move in use the vacuum head towards and away from the crypt wall. The first frame member may be mounted to the main support arm by means of one or more slide rods which permit movement of the first frame member in parallelism towards and away from the main support arm. The slide rods may be selectively locked to the main support arm to lock the support frame assembly in a set position.

Each support frame assembly also suitably includes a second frame member which is mounted for adjustable movement in a substantially horizontal direction relative to the first frame member Means are suitably provided for effecting the horizontal adjustment. The adjusting means may comprise screw adjusting means. Most preferably, the second frame member is mounted on slide rods for movement towards and away from the first frame member.

The support frame assembly preferably also includes a third frame member which is mounted to the second frame member for adjustment in a vertical direction. Means are suitably provided for effecting vertical adjustment of the third frame member. The adjusting means may comprise screw adjusting means. Most preferably, the screw adjusting means comprises an elongated threaded rod which is threadably engaged with one or more threaded members or lugs fixed to the second frame member. The third frame member suitably is supported on the threaded rod and is movable in a vertical direction with a stop fixed to the threaded rod. Preferably, the third frame member is capable of limited pivotal movement about a vertical axis defined by the threaded rod.

The vacuum head is preferably mounted to the third frame member for movement towards and away from the crypt wall. The vacuum head is preferably supported to the third frame member through linkage means. The linkage means may be actuated to move a crypt front engaged by the vacuum head away from the crypt wall. The linkage means may also be actuated to tilt the vacuum head about a horizontal axis or elevate or lower the vacuum head.

The linkage means preferably comprises a first lower link assembly. The lower link assembly preferably includes a link pivotally connected to the vacuum head and the third frame member of the support frame assembly and pivotal movement of the link in one direction causes the vacuum head to be moved in use away from the crypt wall and be elevated whilst movement of the link in the opposite direction causes the vacuum head to be moved in use towards the crypt wall and lowered. Preferably, the link includes an extended manually operable first lever arm. The link is also preferably adapted to directly engage the crypt front when detached from a crypt wall and to move the lower end of the crypt front onto a supporting ledge fixed to the third frame member of the support frame assembly to provide additional support to the crypt front whilst being held by the vacuum head. The link assembly may include means such as a hook or restraint which locates on the inner side of the crypt front to maintain the lower end of the crypt front on the supporting ledge.

Preferably, the linkage means also includes a second upper link assembly, the second link assembly suitably including a link, and means pivotally connect the link at one end to the vacuum head and at its other end to a second lever arm. Means are suitably provided for guiding the pivotal connecting means at the one end horizontally and vertically. Preferably the pivotal connection at the one end is suitably guided for movement along a slot which guides movement of the pivotal connection in a horizontal direction and a vertical direction. The slot suitably includes a substantially horizontal portion and a vertical or vertically inclined portion The guide means is such that the upper end of the vacuum head is guided substantially horizontally away from the crypt wall upon operation of the second lever arm of the upper link assembly and then upwardly and outwardly upon operation of the first lever arm of the lower link assembly.

The upper and lower link assemblies however may be adjusted or varied in their configuration and functions depending upon the nature of the connection of the crypt front to the crypt wall and the movement required to move the crypt front out of the crypt wall.

The apparatus may also include bracing means which are selectively movable into abutment with the crypt wall adjacent the crypt front to be removed or replaced to provide support during handling of a crypt front. The bracing means may additionally or alternatively be arranged to brace the apparatus to a ceiling or floor depending upon the location of the apparatus and crypt front to be removed.

The present invention in a further aspect provides a method of handling crypt fronts, said method including the steps of providing vacuum head means, positioning said vacuum head means in abutment with a said crypt front and applying a vacuum or partial vacuum to said vacuum head means such that said vacuum head means grips said crypt front and moving said vacuum head means towards or away from a crypt wall for placement of said crypt front into, and removal of crypt front from, said crypt wall.

The present invention in a further preferred aspect provides apparatus for handling crypt fronts of the type normally supported on a crypt wall, said apparatus including crypt front engaging means for engaging and supporting a said crypt front, means for supporting said crypt front engaging means for movement in opposite vertical directions whereby said crypt front engaging means may be moved between a lowered position for unloading or loading a said crypt front at ground level and an elevated position for placement of a crypt front into, or removal of crypt front from, said crypt wall. Preferably the crypt front engaging means is supported on or adjacent a platform and means are provided for elevating or lowering the platform. Suitably, the crypt front engaging means is mounted adjacent one side of the platform. Preferably, the apparatus includes means for supporting a crypt front in a tilted attitude on the platform.

### BRIEF DESCRIPTION OF THE DRAWINGS

In order that the invention may be more readily understood and put into practical effect, reference will now be made to the accompanying drawings which illustrate a preferred embodiment of the invention and wherein:

FIG. 1 illustrates in side perspective view the crypt front handling apparatus approaching a crypt front engaging position;

FIG. 2 is a perspective view of the apparatus of FIG. 1 from the rear;

FIG. 3 is a perspective view of one of the crypt front engaging assemblies showing the vacuum head;

FIG. 4 illustrates in side elevation, a crypt front engaging assembly engaged with a crypt front;

FIG. 5 illustrates in opposite side elevation, details of the vertical adjustment arrangement;

FIG. 6 illustrates in elevation view, a brace assembly for use with the apparatus;

FIGS. 7 to 9 illustrate in a side elevational view, the manner in which a crypt front is removed from the crypt wall and supported for lowering to the ground;

FIGS. 10 to 12 illustrate alternative bracing or stabilising arrangements for the apparatus.

### DETAILED DESCRIPTION OF THE PREFERRED EMBODIMENT

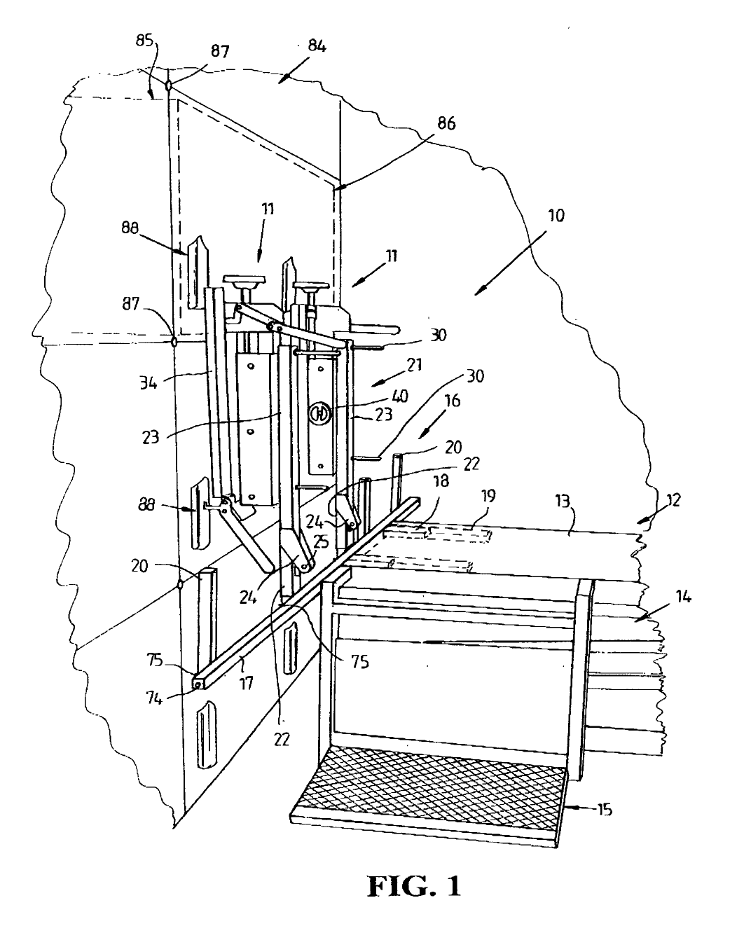

Referring firstly to FIGS. 1 to 6, there is illustrated crypt front handing apparatus 10 according to a preferred embodiment of the invention comprising a pair of crypt front engaging and supporting assemblies 11 which are mounted on a scissor lift platform assembly 12 including a main planar platform 13 upon which operators may stand to operate the apparatus 10 and which may be elevated or lowered by means of a conventional scissor link mechanism 14 capable of being extended and retracted by a pneumatic or hydraulic ram The platform assembly 12 may also include opposite downwardly stepped hinged side platforms 15 upon which an operator or operators may be supported to operate the apparatus 10. The apparatus 10 further includes a main support frame 16 which includes an elongated frame member 17 which is supported substantially horizontally by means of a plurality of horizontal support arms 18 which project into horizontal hollow frame members or sockets 19 in the platform assembly 12 to support the elongated frame member 17 adjacent to a side of the platform 13. Sockets 19 may be provided in opposite ends and sides of the platform assembly 12 to permit the frame 16 to be supported at a side or end of the platform 13. The frame member 17 carries a number of spaced apart upright spigot-like frame members 20 which can support respective crypt front engaging and supporting assemblies 11. Usually two such assemblies 11 are provided supported on respective frame members 20 at a suitable spacing however where larger crypt fronts are required to be handled, more than two assemblies 11 may be provided each being supported on an upright frame member 20.

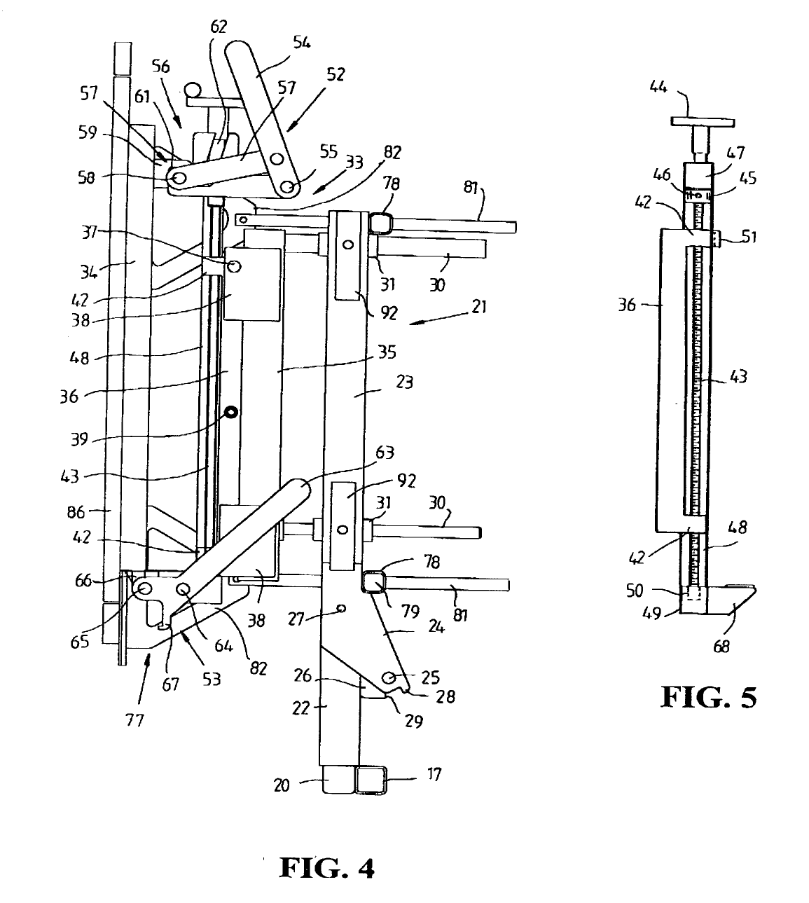

Each crypt front engaging and supporting assembly 11 includes a main support arm 21 comprising a lower socket part 22 which may located over one of the spigot-like frame members 19, and an upper main part 23. As shown more clearly in FIG. 4, a pair of cheek plates 24 are secured to opposite sides of the part 23 at its lower end and are mounted to a pivot pin 25 supported by a bracket 26 fixed to the socket part 22 such that the arm part 23 in use is supported for pivotal movement about a substantially horizontal pivot axis defined by the pivot pin 25. A latching or pinning member 27 can be passed though the cheek plates 24 and the socket part 22 to pin or latch the arm part 23 in a normally upright attitude aligned with the socket part 22. A stop bar or member 28 is fixed to and extends between the cheek plates 24, the stop bar 28 abutting against portion 29 of the bracket 26 upon pivotal or tilting movement of the arm part 23 to limit pivotal or tilting movement of the arm part 23 as described further below.

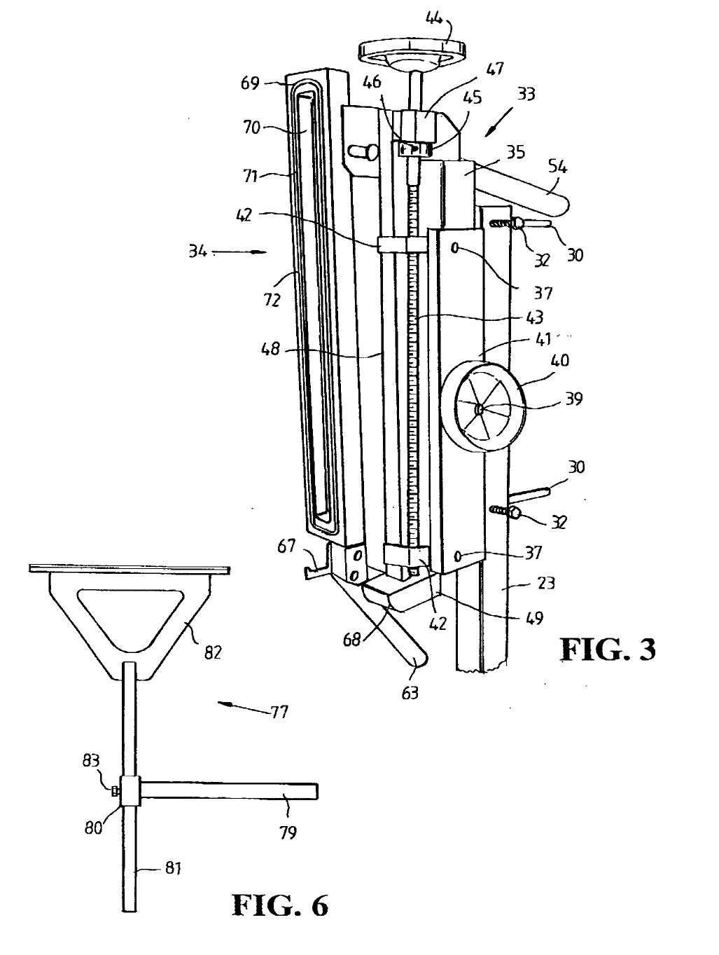

The arm part 23 carries a pair of spaced apart slide arms 30 which extend normal to the arm part 23 and which are slidably mounted thereto via bearings or bushes 31. Lock screws 32 (see FIG. 3) can be used to lock the arms 30 in a desired position relative to the arm part 23. The slide arms 30 support an adjustable frame assembly shown generally at 33 which carry a crypt front engaging bead 34.

The frame assembly 33 includes a first frame member 35 which is connected to the arms 30 so as to be movable with the arms 30 towards and away from the arm part 23. A second adjustable frame member 36 extending substantially parallel to the frame member 35 is mounted via upper and lower slide rods 37 and upper and lower brackets 38 to the frame member 35 for transverse movement in parallelism relative to the frame member 35. An adjustment screw 39 terminating in a handle 40 is also rotatably supported to the frame member 35 via brackets 41 between the upper and lower brackets 38. The brackets 38 and 41 may be replaced by a common bracket as is apparent in FIGS. 1 and 3. The screw 39 is in threaded engagement with the second frame member 36 such that rotation of the handle 40 in opposite directions will cause movement of the second frame member 36 in opposite horizontal directions towards and away from the first frame member 35. This allows for fine horizontal adjustment of the second frame member 36 and thus for fine horizontal adjustment of the crypt front engaging head 34.

The second frame member 36 carries a pair of upper and lower threaded lugs 42 with which an elongated vertical adjustment threaded rod 43 is threadably engaged, the rod 43 being provided at its upper end with an adjustment handle 44 for effecting rotation of the rod 43 and thereby vertical adjustment of the rod 43 relative to the frame member 36. A bush like stop 45 is fixed to the rod 43 by means of a lock screw 46 A bearing block 47 is located about an unthreaded portion of the rod 43 above the stop 45 and seats on the stop 45. The bearing block 47 is fixed to a third elongated frame member 48, the frame member 48 also carrying a support block 49 at is lower end into which the lower end of the rod 43 extends to be rotatably supported in a blind bore 50 therein. It will thus be appreciated that rotation of the handle 44 will cause movement of the rod 43 in opposite directions which will cause through the seating of the bearing block 47 on the stop 45 opposite vertical movement of the third frame member 48. Excessive pivotal movement of the frame member 48 about the rod 43 is limited by a stop lug 51 however the frame member 48 is allowed a limited degree of pivotal movement for alignment purposes.

The crypt front engaging head 34 is mounted through upper and lower lever assemblies 52 and 53 to the third frame member 48. The upper lever assembly 52 includes a lever arm 54 pivotally mounted at 55 to a bracket 56 fixed to one side of the frame member 48. A connecting link 57 is pivotally connected at each end to the arm 54 and via a pin 58 to a lug 59 fixed to the rear of the crypt front engaging head 34. The pin 58 extends into a slot 60 in the bracket 56 to be guided for movement, the slot 60 being of a dog-leg shape and including a substantially horizontal portion 61 and a substantially vertical or vertically and outwardly inclined portion 62 so as to guide the pin 58 both horizontally and vertically as described further below.

The lower lever assembly 53 includes a lever arm 63 which is pivotally mounted at 64 to the lower end of the frame member 48 and at 65 to a lug 66 on the rear of the crypt front engaging head 34. The lever arm 63 is extended to define a hook 67 for engaging the lower end of a crypt front as described further below. The frame member 48 also carries a lug 68 adjacent the lever assembly 53 which forms a ledge onto which the lower end of a crypt front may be moved by the lever assembly 53. Preferably, the lug 68 is padded or cushioned to prevent damage to the lower edge of a crypt front when removed from a crypt wall.

The crypt front engaging head 34 comprises as shown more clearly in FIG. 4, an elongated body 69 which has an elongated hollow recess 70 on one side which is surrounded by an O-ring type seal 71 located with an endless grove 72 surrounding the recess 70. A port 73 on the rear face of the head 34 communicates with the recess 70 and is arranged in use to be connected to a vacuum source such as a vacuum pump or suction pump through suitable ducting and via suitable valving. The vacuum source may be connected to the main support frame 16, the frame members 17, 18 and 20 of which are formed of interconnected hollow members to form a sealed vacuum reservoir or manifold For this purpose, the frame 16 may include a port connection 74 (see FIG. 1) at one end of the frame member 17 for connection to the vacuum or suction source. Outlet connectors or ports 75 are provided on the frame member 17 adjacent each spigot-like frame member 20. A manually operated valve 76 may be supported on each socket part 22 for connection to the port 75 adjacent to the spigot-like member 20 on which the socket part 22 is mounted and to the port 73 of the crypt front engaging head 34.

The main support arm 21 may also carry brace assemblies 77 (see FIGS. 4 and 6) and for this purpose, the upper arm part 23 may carry upper and lower sockets 78 extending transversely of the arm part 23 for supporting the brace assemblies 77. Each brace assembly 77 comprises a holder arm 79 which may be located in a socket 78 and be fixed thereto by a lock screw. The holder arm 79 carries at its free end, a socket 80 for slidable support of a rod 81 which terminates in a padded face engaging member 82. The rod 81 may again be locked in a desired position relative to the socket 80 by means of a locking screw or pin connection 83.

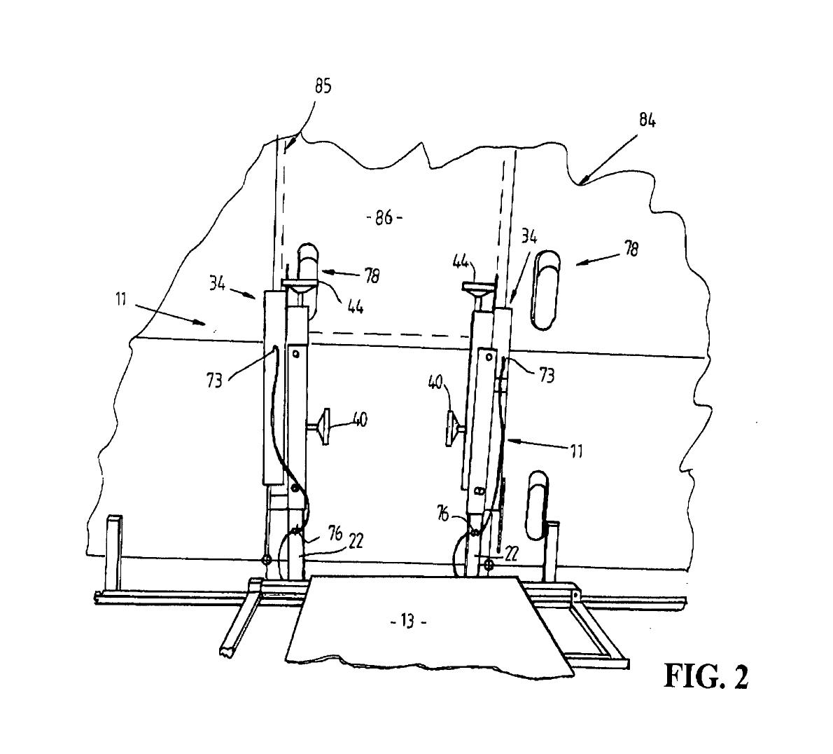

A mausoleum or crypt wall shown generally at 84 in FIGS. 1 and 2 is formed of a plurality of rectangular crypt chambers 85 (shown in dotted outline) which may be of different sizes or configurations depending upon the number of coffins or caskets to be held therein and which are arranged at multiple levels. The chambers 85 are open at their outer ends and their outer ends after entombment are closed off and sealed with end panels and finished with an overlying panel which forms a crypt fronts 86. Usually the fronts 86 are formed of stone such as marble or granite and are normally of a rectangular configuration. The crypt fronts 86 may be held in position by screwed in corner fasteners 87 which overlie for corners of adjacent fronts 86. Alternatively the fronts 86 are supported through a tongue in groove type joint wherein the fronts 86 are supported in recesses or grooves at their top and bottoms edges and are required to be elevated to move the lower ends out of the lower groove and then lowered to move the upper end out of the upper groove. Usually leaf-type springs are provided behind the fronts 86 to bias the fronts 86 outwardly so that they all lie in a common plane. The fronts 86 may also carry decorative lanterns 88 (shown in FIGS. 1 and 2) which are normally located towards opposite sides of the fronts 86. The face of the crypt front 86 may also carry lettering between the lanterns 88 which for example may be in the form of adhered letters.

In use and for removal of a crypt front 86 from the wall 84, the lift platform assembly 12 carrying a pair of crypt front supporting and engaging assemblies 11 is positioned adjacent the crypt wall 84 and the platform 13 is then elevated by the scissor link mechanism 14 to place the assemblies 11 adjacent to a particular crypt front 86 to be removed. The assemblies 11 are supported at a set spacing on selected spigot-like members 20 according to the width of the crypt front 86 to be removed and such that the assemblies 11 are spaced apart approximately the width of a crypt front 88. The crypt engaging heads 34 may he provided at their upper ends with a gauging member (not shown) so that the platform 13 can be elevated to a position where the gauging member is aligned approximately with the upper edge of a crypt front 86. The frame assembly 33 supported by the slide arms 30 is then slid inwardly towards the wall 84 to move the respective crypt front engaging heads 34 into register and contact with the crypt front 86 as shown in FIG. 4. Fine adjustment of the position of the heads 34 in both a horizontal and vertical direction may be achieved by rotation of the handles 40 and 44 in opposite directions as described above. The heads 34 are usually positioned on the outside of the lanterns 88 which is possible because of the elongated nature of the vacuum heads 34 but may be positioned at any other accessible location on a crypt front 86.

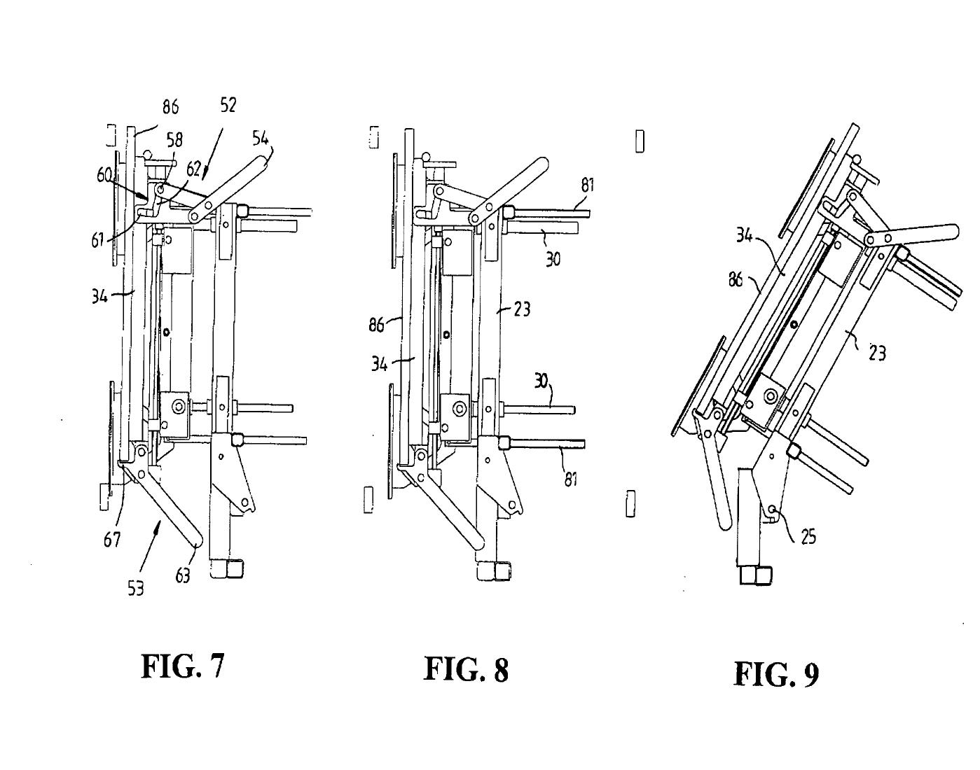

After positioning of the vacuum heads 34 in the correct position and in contact with the crypt front 86, a vacuum or partial vacuum is applied to The heads 34 by opening the valves 76 such that the heads 34 by suction pressure firmly grip the front 86 at spaced apart locations. For stable support of the apparatus 10, upper and lower brace assemblies 77 may be supported by the sockets 78 and the support rods 81 advanced to move the face engaging members 82 into engagement with the crypt wall 84 on either side of the front 86 to be removed Where the crypt front 86 is held in position by corner screw fasteners 87, they are removed The lever assemblies 52 and 53 may then be operated by hand to move the engaged crypt front 86 outwardly of the wall 84. Initially, the lever arm 54 of the upper lever assembly 52 may be moved from the position of FIG. 4 to that of FIG. 7 to tilt or pivot the top of the front 86 outwardly, the pin 58 being guided along the generally horizontal portion 61 of the slot 60 during this movement. The upper two corner fasteners 87 are then replaced to hold the other adjacent crypt fronts 86 in position. The lower lever assembly 53 may be pivoted from the position of FIG. 4 to that of FIG. 7 to move the lower end of the crypt front 86 outwardly and upwardly onto the ledge 68. During upward movement of the crypt front 86 as effected by the lever assembly 53, the pin 58 of the upper lever assembly 52 is guided in movement along the vertically inclined portion 62 of the slot 60 In the position of FIG. 4, it will be apparent that the hook or lug 67 of the lever arm 63 locates on the rear side of the crypt front 86 to provide further support to the front 86 and maintain it on the ledge 68. The frame assembly 33 may be retracted by sliding it rearwardly towards the arm part 23 as allowed by the slide rods 30. The brace assemblies 77 may also be retracted from the crypt wall 84 by releasing the lock screws 83 and retracting the rods 81 as shown in FIG. 8. In this position, the crypt front 86 is moved away from the wall 84 as are the face engaging members 82.

Prior to lowering the platform 12 to the ground, the upper arm pans 23 are released and tilted or pivoted rearwardly about the axis of the pivot pin 25 to an extent limited by engagement of the stop 28 with the bracket part 29 such that the crypt front 86 held by the vacuum heads 34 is also tilted as shown in FIG. 9. This positions the centre of gravity of crypt front 86 over the platform assembly 12 to ensure stability during lowering of the platform 13 and also ensures that the crypt front 86 is moved clear of any likely obstruction such as the lanterns 88 on the crypt wall 84. The platform 13 is then lowered to the ground to enable the crypt front 86 to be removed by hand for the purposes of engraving, print or lettering application or for any other purpose.

Where the crypt front 86 is held by an alternative support arrangement to the wall 86 such as in upper and lower grooves, after engagement of the heads 34 with the front 86 and application of vacuum to the heads 34 as described above, upper and lower lever assemblies are actuated to initially lift the crypt front 86 upwardly to free the lower end of the crypt front 86 and move it to a position where it can be moved outwardly. Actuation of the lower lever assembly will then move the lower end of the crypt front 86 outwardly. Further actuation of the lever assemblies causes lowering of the crypt front 86 to release the top of the front 86 from the upper groove. The top of the front 86 may then be moved outwardly by the lever assemblies to the position of FIG. 7 and the front 86 then moved to the positions of FIGS. 8 and 9 for lowering to the ground The upper and lower lever assemblies to achieve the above movements are similar to the lever assemblies 52 so as to guide the vacuum head 34 both horizontally and vertically.

Where it is desired to place or replace the crypt front 86 into the wall 84 after for example an entombment, the reverse procedure to that described above is adopted.

Usually where small or medium size crypts are involved, the above operations can be undertaken by one person. Where the crypts are large two or more persons may be required.

Whilst most of the actions of the apparatus as described above are achieved manually such as by rotating the handles 40 and 44 and operation of the lever assemblies 52 and 53, it will be appreciated that these functions can be carried out by suitable drive motors or actuators. Of course many different arrangements other than that described may be provided for supporting the heads 34 and effecting the required movement thereof. Further whilst the engaging assemblies 11 are described as being associated with a scissor lift platform assembly 12, they may be used with any form of elevating apparatus which will provide access to the crypt fronts 86 located at any position on the wall 84.

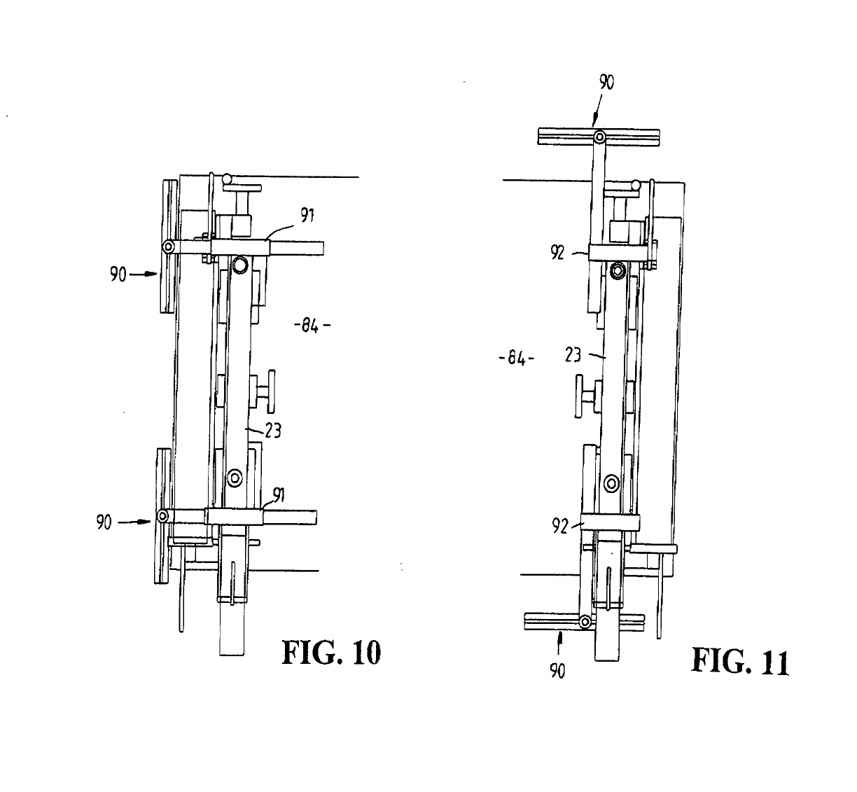

FIGS. 7 to 9 illustrate alternative bracing arrangements for the apparatus 10. Thus in FIG. 10, brace assemblies 90 for engaging a side wall adjacent to the crypt wall 84 upon which the apparatus 10 is working may be supported in sockets 91 on the arm part 23 in a horizontal attitude from which they may be extended to engage the side wall. In the arrangement of FIG. 11, the brace assemblies 90 may be repositioned in the sockets 92 in a vertical attitude where engagement with a ceiling and/or floor is required to provide sufficient bracing to the apparatus 10 and platform assembly 12.

Whilst the above has been given by way of illustrative embodiment of the invention, all variations and modifications thereto as would be apparent to persons skilled in the art are deemed to fall within the broad scope and ambit of the invention as herein defined in the appended claims.

1. Apparatus for handling crypt fronts of the type normally supported in or forming a crypt wall, said apparatus comprising:
vacuum head means,
means for applying a vacuum or partial-vacuum to said vacuum head means to enable said vacuum head means to grip said crypt front, and
means for supporting said vacuum head means for movement towards and away from a crypt wall for placement of a crypt front into, or removal of crypt front from, said crypt wall.

2. Apparatus according to claim 1 wherein the or each vacuum head means comprises an elongated body defining an elongated hollow recess, said recess beings open on one side and means for communicating said recess with a vacuum or a partial vacuum source.

3. Apparatus according to claim 2 wherein said open side of said recesses is provided with sealing means for sealing said recess to said crypt front.

4. Apparatus according to claim 1 and including a support frame assembly for supporting a said vacuum head means, said support frame assembly being supported on an elevating and lowering device for raising and lowering said vacuum head means and crypt front engaged thereby.

5. Apparatus according to claim 4 wherein said elevating and lowering device comprises a mobile platform assembly and means for elevating or lowering said platform assembly.

6. Apparatus according to claim 5 wherein said support frame assembly is pivotally mounted to said elevating or lowering device for movement about a substantially horizontal axis for moving a crypt front when gripped by the vacuum head means to a tilted position overlying said elevating and lowering device.

7. Apparatus according to claim 5 and including means for supporting said support frame assembly to one side or end of said elevating and lowering device.

8. Apparatus according to claim 7 wherein said means for supporting said support frame assembly comprises a main support frame detachably mountable to said elevating and lowering device, said main support frame including means for supporting a said support frame assembly at selected spaced positions thereon.

9. Apparatus according to claim 8 wherein said main support frame includes a plurality of spaced upstanding spigot-like frame members and wherein said support frame assembly includes a main support arm, said main support arm having a socket part for location over a said spigot-like frame member.

10. Apparatus according to claim 9 wherein said main support arm includes an upper arm part pivotally mounted to said socket part for pivotal movement about a substantially horizontal pivot axis.

11. Apparatus according to claim 4 wherein said support frame assembly is adapted to mount said vacuum head means to said elevating and lowering device for movement towards and away from a crypt front.

12. Apparatus according to claim 11 wherein said support frame assembly includes means for selectively adjusting said vacuum head means in a vertical direction and a sideways or lateral direction for positioning of said vacuum head means on a said crypt front.

13. Apparatus according to claim 9 wherein said support frame assembly includes a first frame member mounted to said main support arm for movement towards and away from the main support arm, a second frame member mounted for adjustable movement in a substantially horizontal direction relative to the first frame member, and a third frame member mounted to said second frame member for adjustable movement in a vertical direction, and means for adjusting the position of said second frame member and third frame member.

14. Apparatus according to claim 12 wherein said vacuum head means is mounted to the said support frame assembly by linkage means, said linkage means being operable to move a crypt front engaged by said vacuum head means away from said crypt wall.

15. Apparatus according to claim 18 wherein said linkage means is operable to tilt said vacuum head means about a horizontal axis or elevate or lower said vacuum head means.

16. Apparatus according to claim 15 wherein said linkage means comprises a first lower link assembly, said lower link assembly comprising a link pivotally connected to said vacuum head means and said support frame assembly, said link being extended to define a first lever arm, and wherein pivotal movement of said lever arm in a first direction causes elevation of said vacuum head means.

17. Apparatus according to claim 16 wherein said support frame assembly includes a supporting ledge for supporting a lower edge of said crypt front, and wherein said pivotal movement of said lever arm causes said crypt front to be moved onto said supporting ledge.

18. Apparatus according to claim 16 wherein said linkage means includes a second upper link assembly, said upper link assembly including a link, means pivotally connecting said link at one end to said vacuum head means and at its other end to a second lever arm and means for guiding movement of said pivotal connecting means at said one end horizontally and vertically.

19. Apparatus according to claim 18 wherein actuation of said second lever arm causes movement of said pivotal connecting means horizontally and wherein actuation of said first lever arm causes movement of said pivotal connecting means vertically.

20. Apparatus according to claim 1 and including bracing means which are selectively movable into abutment with said crypt wall adjacent the crypt front to be removed or replaced to provide support during handling of a crypt front.

21. A method of handling crypt fronts in a crypt wall, said method including the steps of:
providing vacuum head means,
positioning said vacuum head means in abutment with a said crypt front,
applying a vacuum or partial vacuum to said vacuum head means such that said vacuum head means grips said crypt front, and
moving said vacuum head means towards or away from said crypt wall for placement of said crypt front into, and removal of crypt front from, said crypt wall.

22. Apparatus for handling crypt fronts of the type normally supported on a crypt wall, said apparatus comprising:
crypt front engaging means for engaging and supporting a said crypt front,
means for supporting said crypt front engaging means for movement in opposite vertical directions whereby said crypt front engaging means may be moved between a lowered position for unloading or loading a said crypt front at ground level and an elevated position for placement of a crypt front into, or removal of crypt front from, said crypt wall.

23. Apparatus according to claim 22 wherein said crypt front engaging means is supported on or adjacent a platform and means are provided for elevating or lowering the platform.

24. Apparatus according to claim 23 wherein said crypt front engaging means is mounted adjacent one side of the platform.

25. Apparatus according to claim 24 and including means for supporting a crypt front in a tilted attitude on said platform.
